(19) United States
(12) Patent Application Publication
(10) Pub. No.: US 2010/0116087 A1
(43) Pub. Date: May 13, 2010

(54) TRANSMISSION DEVICE WITH TRANSMISSION HOUSING

(75) Inventor: Michael MUELLER, Ravensburg (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/603,039

(22) Filed: Oct. 21, 2009

(30) Foreign Application Priority Data
Nov. 11, 2008 (DE) 10 2008 043 629.1

(51) Int. Cl. F16H 57/02

(52) U.S. Cl. 74/606 R

(57) ABSTRACT

A transmission device (1) with a transmission housing (2) having at least one inside space (5) of a first transmission housing portion (3) that can be acted upon by hydraulic fluid and having at least one second transmission housing portion (4). An inside space (6) of the second transmission housing portion (4) is separated from the inside space (5) of the first transmission housing portion (3). A sealing system (10) is provided between the two transmission housing portions (3, 4) for at least sealing the inside space (5) of the first transmission housing portion (3) against the escape of oil from the transmission housing (2). The inside space (5) of the first transmission housing portion (3) is connected to the inside space (6) of the second transmission housing portion (4) by a venting system (12). The connection between the inside space (5) of the first transmission housing portion (3) and the inside space (6) of the second transmission housing portion (4) passes at least once through a sealing element (11) of the sealing system (10).

This application claims priority from German Application Serial No. 10 2008 043 629.1 filed Nov. 11, 2008.

### FIELD OF THE INVENTION

The invention concerns a transmission device with transmission housing of the type defined in more detail below.

### BACKGROUND OF THE INVENTION

In transmission devices known from practice, the transmission housings are usually vented in the area of bores passing through the transmission housing, in which, respectively, a venting tube and a venting cover are attached to the transmission housing essentially on the outside. Such venting systems are characterized by a simply designed structure and low manufacturing costs.

Disadvantageously, oil vapors emerge from the inside of the housing, in the area of the venting system, during operation of the transmission devices which, in some circumstances, can make their way into the inside space of the vehicle through a ventilation or air-conditioning system and result in undesired odors.

To avoid this, the venting systems are combined with so-called hose vents which pass the oil vapors, emerging from inside the transmission, into the engine inlet manifold of an internal combustion engine of a vehicle. However, such measures disadvantageously increase the production costs of a transmission device.

Furthermore, with the above-described transmission devices, there is a possibility that condensation water, dripping onto the external components of the venting system, for example from an air-conditioning unit, will penetrate to the inside of the transmission via the venting system; this is undesirable but can also be avoided, for example by using the said, cost-increasing hose vents.

In the case of other transmission devices known from practice, both the penetration of condensation water to the inside of the transmission housing and odors unpleasant for the vehicle's passengers are avoided by fitting venting devices to connect inside spaces of a first portion of the housing that can be acted upon by hydraulic fluid, at least during operation, to inside spaces of a second portion of the housing, without venting them into the latter by means of additional components such as venting tubes and suchlike.

In the transmission devices of this type, the respective inside space of a first transmission housing portion is vented into the inside space of the second transmission housing portion through the wall of the transmission housing via an area located radially outside the sealing system which seals the two inside spaces of the two transmission housing portions.

In the venting area between the two transmission housing portions there is a metallic surface-contact area in the vicinity of which, however, oil-tightness can unfortunately not be guaranteed so that, under unfavorable operating conditions, an undesired escape of oil or hydraulic fluid from a transmission device can take place through venting systems of this type.

### SUMMARY OF THE INVENTION

The purpose of the present invention is therefore to provide a transmission device in which at least one inside space of a first housing portion, which can be acted upon with hydraulic fluid at least during operation, is connected by a venting device through which it can be vented, to an inside space of a second housing portion, such that unpleasant odors, the penetration of condensation water into the transmission housing, and the escape of oil from the transmission housing are avoided by simply designed and inexpensive means.

In the transmission device according to the invention, which has a transmission housing with at least one first transmission housing portion that can be acted upon in an inside space with hydraulic fluid and with at least one second transmission housing portion, such that an inside space of the said second transmission housing portion is separated from the inside space of the said first housing portion, and between the two transmission housing portions a sealing system is provided at least to seal the inside space of the first transmission housing portion against an escape of oil from the transmission housing, and such that the inside space of the first transmission housing portion is connected, by a venting system, to the inside space of the second transmission housing portion, the connection between the inside space of the first transmission housing portion and the inside space of the second transmission housing portion passes at least once through a sealing element of the sealing system.

Thus with the transmission device according to the invention, odors annoying for passengers in a vehicle are avoided in a simple and inexpensive manner since the first transmission housing portion, that contains the hydraulic fluid, is vented into the second transmission housing portion, so that oil vapors are not released into the surroundings of the transmission device. Moreover, both the penetration of condensation water into the transmission housing and any escape of oil or hydraulic fluid from the transmission housing, in the area of the venting system, are prevented by the fact that the two transmission housing portions, or their inside spaces, are sealed from the surroundings by the sealing system to the desired extent and a leak-point known from previous practice in the area of the venting system is reliably avoided by the sealing element of the sealing system.

In an advantageous further development of the transmission device according to the invention, the inside space of the first transmission housing portion is delimited in an area facing toward the second transmission housing portion by the latter, and the inside space of the first transmission housing portion is connected, via an opening of the second transmission housing portion and a bore of the sealing element, to a hollow space of the venting system delimited by the first transmission housing portion and the sealing element.

Thus, the venting system by which the two transmission housing portions or their inside spaces are connected to one another, is made in the manner of a labyrinth that effectively prevents any escape of hydraulic fluid from the inside space of the first transmission housing portion toward the inside space of the second transmission housing portion.

In a further development of the transmission device according to the invention, the hollow space of the venting system delimited by the first transmission housing portion and the sealing element is connected, via a through-going bore of the sealing element, to a hollow space of the venting system delimited by the second transmission housing portion and the sealing element so that the labyrinth of the venting system, which prevents oil from escaping from the inside space of the first transmission housing portion into the inside space of the second transmission housing portion, is extended compared with the embodiment of the transmission device according to the invention described above, and oil transfer from the first transmission housing portion toward the second transmission housing portion is made even more difficult.

In a further advantageous embodiment of the transmission device according to the invention, the escape of hydraulic fluid from the first toward the second transmission housing portion is prevented in that the hollow space of the venting system, delimited by the second transmission housing portion and the sealing element, is connected by a connection line running in the second transmission housing portion to another hollow space of the venting system delimited by the second transmission housing portion and the sealing element, since thereby the labyrinth of the venting system or the path length of the venting system passing between the two inside spaces of the two transmission housing portions is extended still farther.

In a further embodiment of the transmission device according to the invention, the said other hollow space, delimited by the second transmission housing portion and the sealing element, is connected to the inside space of the second transmission housing portion by a bore of the second transmission housing portion.

In a further development of the transmission device according to the invention, the escape of hydraulic fluid from the inside space of the first transmission housing portion into the inside space of the second transmission housing portion, through the venting system, is made still more difficult in that the bore, and the through-going bore of the sealing element of the sealing system, are arranged a distance apart from one another, at least in the circumferential direction of the transmission housing, so that flowing through the venting system involves additional changes of direction and longer paths which make the transfer of oil still more difficult.

In a further embodiment of the transmission device according to the invention, the last-mentioned effect of the venting system is enhanced in that an emergence point of the connecting line in the said other hollow space, delimited by the second transmission housing portion and the sealing element, and the said bore of the sealing element that connects the other hollow space to the inside space of the second transmission housing portion, are a distance apart from one another, at least in the circumferential direction.

In a further advantageous embodiment of the transmission device according to the invention, foaming of the oil in the first transmission housing portion, that favors the transfer of oil from the inside space of the first transmission housing portion into the inside space of the second transmission housing portion, is suppressed in the area of a throttle point, which is formed in the hollow space delimited by the first transmission housing portion and the sealing element in the area between the bore and the through-going bore of the sealing element. In a simple manner, this further impedes an escape of oil from the first toward the second transmission housing portion.

In another advantageous embodiment of the transmission device according to the invention, a sealing action of the sealing system against oil escape, from the transmission housing and against oil transfer from the inside space of the first transmission housing portion toward the second transmission housing portion, is improved still more by a sealing element formed with a sealing rib that extends in the circumferential direction of the transmission housing, which in the assembled position of the sealing element, is positioned as a radial extension of the transmission housing, between the hollow space delimited by the second transmission housing portion and the sealing element, and the said other hollow space also delimited by the second transmission housing portion and the sealing element.

### BRIEF DESCRIPTION OF THE DRAWINGS

Other advantages and advantageous further developments of the invention emerge from the claims and from the example embodiment whose principle is described with reference to the drawings, which show:

FIG. 1: A partial longitudinally sectioned view of a transmission device according to the invention;

FIG. 2: A partial view of a first transmission housing portion of the transmission device 1 in FIG. 1, in which a sealing element is shown transparently in the area of a hollow space delimited by the first transmission housing portion and the sealing element;

FIG. 3: A partial view of a second transmission housing portion of the transmission device 1 in FIG. 1 in which the sealing element is shown transparently in the area of a hollow space and another hollow space, these being delimited by the sealing element and the second transmission housing portion; and

FIG. 4: An enlarged partial longitudinally sectioned view of the transmission device, according to the invention, in which the hollow space delimited by the first transmission housing portion and the sealing element, and the hollow spaces delimited by the sealing element and the second transmission housing portion are shown.

### DETAILED DESCRIPTION OF THE INVENTION

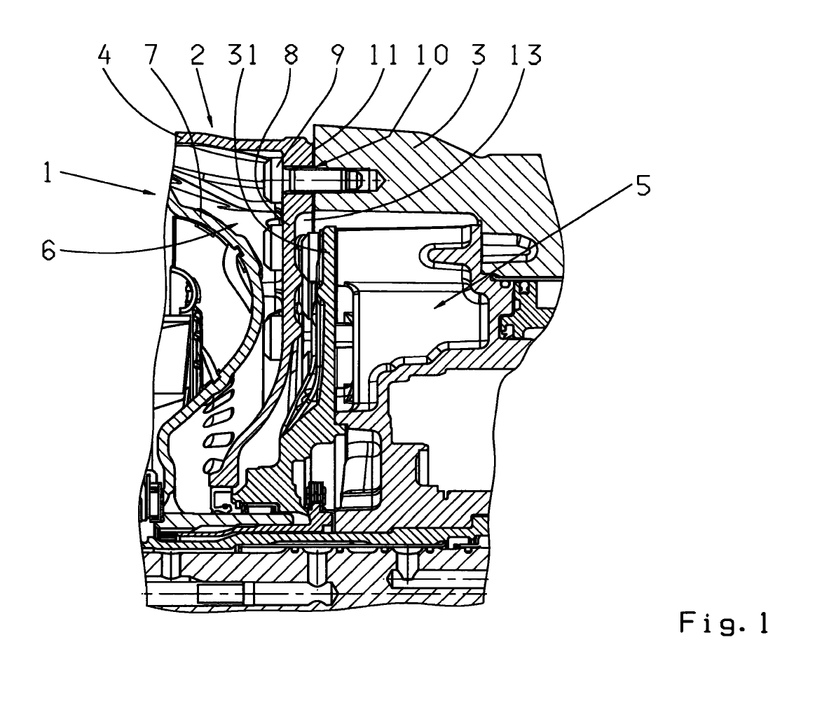

FIG. 1 shows a longitudinally sectioned view of a transmission device 1 with a transmission housing 2 of which, in this case, a first transmission housing portion 3 and a second transmission housing portion 4 are shown in FIG. 1.

In the first transmission housing portion 3, a number of shift elements are arranged for producing various gears which, in the inside space of the said first transmission housing portion 3, can be acted upon by hydraulic fluid at least during operation of the transmission device 1. In the present case, the inside space 6 contains a hydrodynamic torque converter 7 such that the inside space 6, outside the hydrodynamic torque converter 7, is free from oil and the hydrodynamic torque converter 7 itself is operated by a closed oil circuit. The second transmission housing portion 4 which, in the present case, comprises a converter bell, seals the inside space 6 of the second transmission housing portion 4 by means of a wall 8 running, relative to the inside space 5 of the first transmission housing portion 3, essentially as a radial extension of the transmission housing 2.

The two transmission housing portions 3 and 4 are detachably connected to one another by a plurality of bolted joints 9 distributed around the circumference and, in the contact area between the two transmission housing portions 3 and 4, a sealing system 10 is provided for sealing the inside space 5 of the first transmission housing portion 3 against oil escape from the transmission housing 2. In the present case, the sealing system 10 is in the form of a sealing element 11 made as a flat gasket, in this case a sheet component.

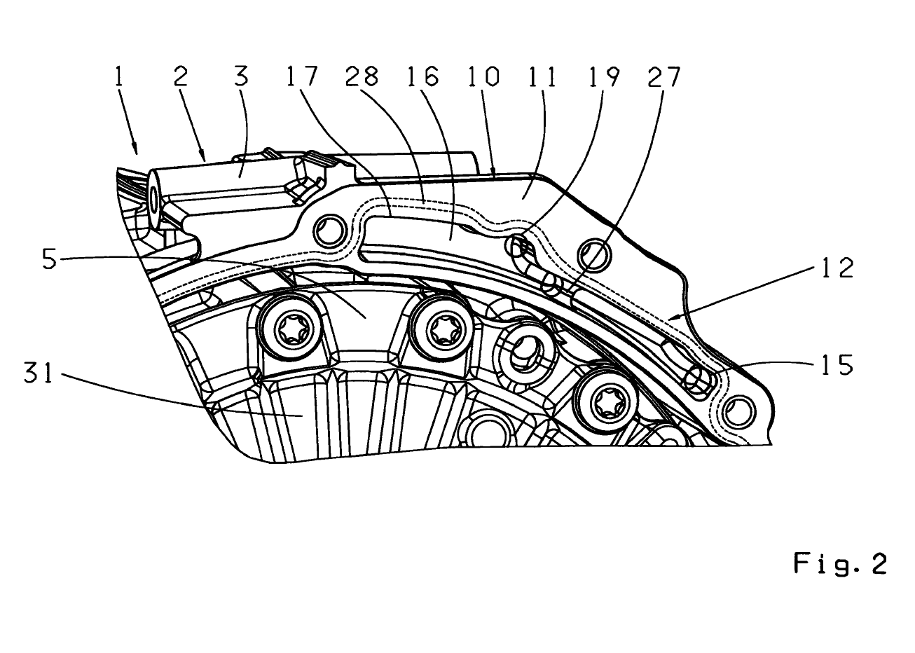

The said inside space 5 of the first transmission housing portion 3 is connected to the inside space 6 of the second transmission housing portion 4 by a venting system 12, shown in greater detail in FIG. 2 to FIG. 4, to vent the inside space 5 of the first transmission housing portion 3. In the present case, the connection between the inside space 5 of the first transmission housing portion 3 and the inside space 6 of the second transmission housing portion 4 passes twice through the sealing element 11 of the sealing system 10, in the manner described below, to avoid the escape of hydraulic fluid or oil from the inside space 5 of the first transmission housing portion 3 through the venting system 12 and into the inside space 6 of the second transmission housing portion 4.

Basically, the transmission device 1 can be made as a variable-speed automatic transmission, an automated manual transmission or even as an infinitely variable automatic transmission in which the shift elements, in the inside space 5 of the first transmission housing portion 3, can be acted upon by hydraulic fluid to produce various transmission ratios, but the hydraulic fluid should not pass into the inside space 6 of the second transmission housing portion 4 through the venting system 12, provided for venting the inside space 5 of the first transmission housing portion 3 toward the inside space 6 of the second transmission housing portion 4.

The inside space 5 of the first transmission housing portion 3 is delimited by the second transmission housing portion 4 in an area 13 facing toward the second transmission housing portion 4. In the example embodiment of the transmission device 1 illustrated in the drawing, the area 13 of the inside space 5 of the first transmission housing portion 3 is delimited by the wall 8 of the second transmission housing portion 4 or converter bell and a centering plate 31 arranged in the inside space 5 of the first transmission housing portion 3.

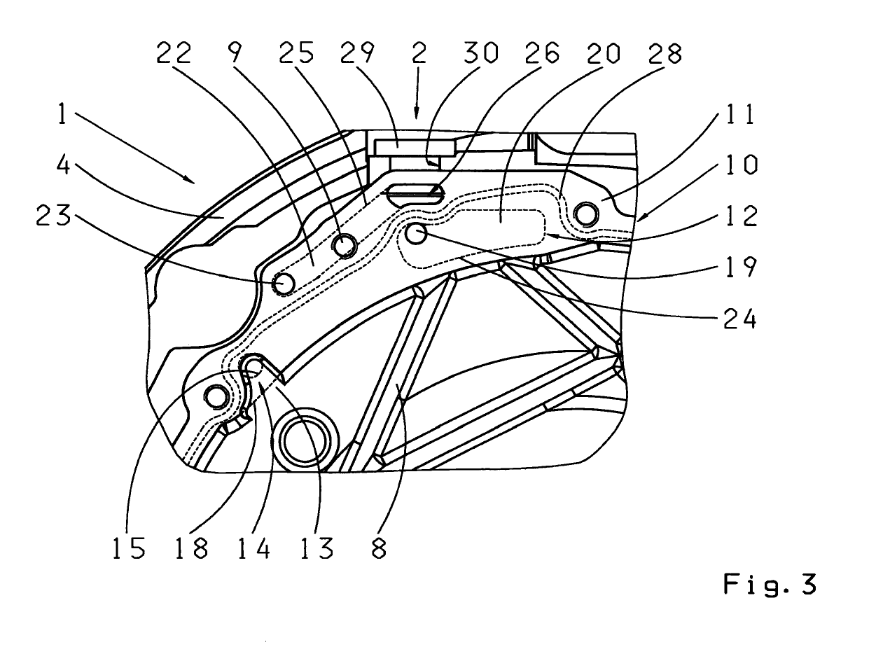

In its area 13, the inside space 5 of the first transmission housing portion 3 is connected, via a pocket-like cutout 14 of the second transmission housing portion 4, shown in FIG. 3, and a bore 15 of the sealing element 11 of the sealing system 10, to a hollow space 16 of the venting system 12 delimited by the first transmission housing portion 3 and the sealing element 11. In FIG. 2, the said hollow space 16 of the venting system 12 is located behind the plane of the drawing and, therefore, behind the sealing element 11 of the sealing system 10. To identify the hollow space 16 more clearly, the sealing element 11 is represented as transparent along the broken line 17 which corresponds to the contour of the hollow space 16. In addition, the sealing element 11 is also represented as transparent in the area shown in more detail by the broken line 18, in FIG. 3, in order to be able to show the cutout 14 of the second transmission housing portion 4.

In turn, the hollow space 16 of the venting system 12 delimited by the first transmission housing portion 3 and the sealing element 11 is connected via a through-bore 19 of the sealing element 11 to a hollow space 20 of the venting system 12 delimited by the second transmission housing portion 4 and the sealing element 11.

In turn again, the hollow space 20 of the venting system 12 bounded by the second transmission housing portion 4 and the sealing element 11 is connected, via a connection line 21 passing through the second transmission housing portion 4, to a further hollow space 22 of the venting system 12 delimited by the second transmission housing portion 4 and the sealing element 11. The said further hollow space 22 delimited by the second transmission housing portion 4 and the sealing element 11 is connected to the inside space 6 of the second transmission housing portion 4 by a bore 23 of the second transmission housing portion 4. In the area of the further hollow space 22, the connection between the two inside spaces 5 and 6 of the transmission device 1 bypasses the venting system 12 at one of the screw joints 9. To enable a better understanding of this, the sealing element 11 in FIG. 3 is again represented as transparent in the area of the hollow space 20 and the further hollow space 22, respectively along the line 24 which diagrammatically reproduces the contour of the hollow space 20, and along the line 25 which reproduces the contour of the further hollow space 22.

To prevent, as effectively as possible, oil escape from the inside space 5 of the first transmission housing portion 3 to the inside space 6 of the second transmission housing portion 4, the bore 15 and the through-bore 19 of the sealing element 11 are arranged a distance apart from one another in the circumferential direction of the transmission housing 2, and the hollow spaces 16, 20 and 22, the bores 15 and 19 and the connection line 21 together form a labyrinth of the venting system 12. The said venting labyrinth of the venting system 12 is located in the upper area of the converter bell 8, when the transmission device 1 is in its fitted position in the vehicle.

In addition, an opening area 26 of the connection line 21 into the further hollow space 22 delimited by the second transmission housing portion 4 and the sealing element 11, and the bore 23 of the second transmission housing portion 4 that connects the further hollow space 22 with the inside space 6 of the second transmission housing portion 4 are a distance apart from one another, in the circumferential direction, and enhance the effect of the labyrinth of the venting system 12 against oil escape from the inside space 5 of the first transmission housing portion 3 into the inside space 6 of the second transmission housing portion 4.

The hollow space 16 delimited by the first transmission housing portion 3 and the sealing element 11 is, in the present case, formed in the area between the bore 15 and through-bore 19 of the sealing element 11, with a throttle point 27 designed as a baffle fin in the area of which oil bubbles of the hydraulic fluid, foamed in the inside space 5 of the first transmission housing portion 3 by shift elements that rotate during the operation of the transmission device 1, are trapped before passing through the hollow space 16 and burst in the area of the said throttle point 27, whereby entry of further hydraulic fluid into the labyrinth of the venting system 12 toward the inside space 6 of the second transmission housing portion 4 is avoided in a simple and effective way.

To increase the sealing action of the sealing system 10, the sealing element 11 is formed with a sealing rib 28 that extends in the circumferential direction of the transmission housing 2 which, when the sealing element 11 is in its fitted position, extends or is provided as a radial extension of the transmission housing 2, between the hollow space 20 delimited by the second transmission housing portion 4 and the sealing element 11, and further hollow space 22 also delimited by the second transmission housing portion 4 and the sealing element 11.

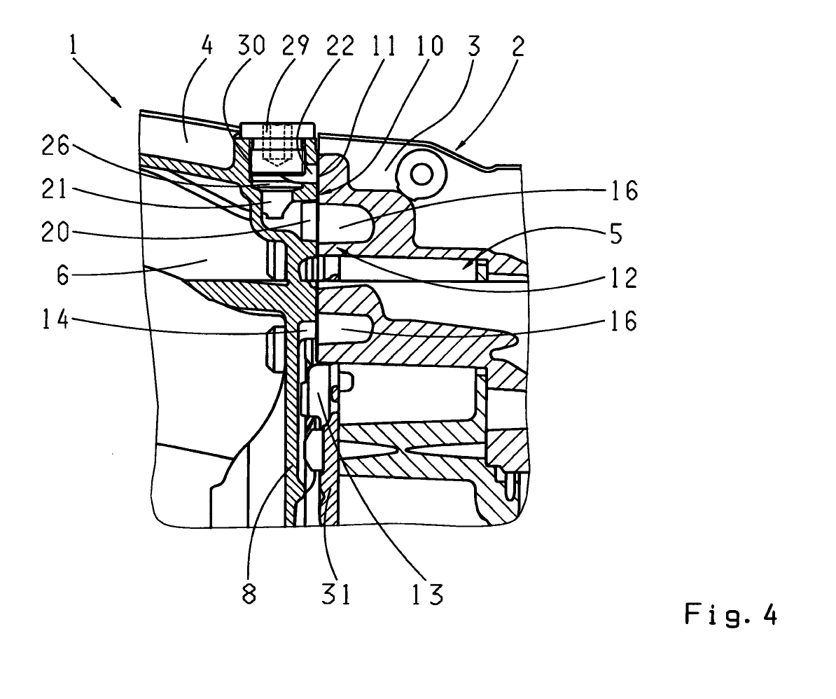

FIG. 4 shows a sealing bolt 29, used to close the transmission housing 2, which is screwed tightly into a bore 30. Through this bore 30 a gas, preferably helium, is admitted during leak-proof testing of the transmission device 1 or its transmission housing 2. After the leak-proof test, the connection between the inside of the transmission and the surroundings of the transmission device 1 must be closed off by the sealing bolt 30.

During the leak-proof testing of the transmission device 1, a component (not shown in the drawing) is fitted into the bore 30 which separates the further hollow space 22 from the connection line 21. At the same time, the said gas can be admitted through the said component into the connection line 21 and thus into the inside space 5 of the first transmission housing portion 3.

When the sealing bolt 29 is fitted into the bore 30, the two inside spaces 5 and 6 of the transmission device 1 are only sealed by the sealing bolt 29 relative to the surroundings, whereas the venting system 12 for venting the inside space 5 of the first transmission housing portion 3 into the inside space 6 of the second transmission housing portion 4 is not interrupted in the area between the connection line 21 and the further hollow space 22 by the sealing bolt 29.

In the area of the venting system 12, the transmission device 1 is designed, according to the invention, with a complex labyrinth between the converter bell 8, the sealing system 10, the inside space 5 of the first transmission housing portion 3 and the inside space 6 of the second transmission housing portion 4, this labyrinth system being very largely configured by the basic component geometry of the two housing portions 3 and 4. Thus only minimal machining is required, making it possible to produce inexpensively the transmission device 1 according to the invention.

### Indexes

1 Transmission device

2 Transmission housing

3 First transmission housing portion

4 Second transmission housing portion

5 Inside space of the first transmission housing portion

6 Inside space of the second transmission housing portion

7 Hydrodynamic torque converter

8 Wall (of the second transmission housing portion)

9 Screw joints

10 Sealing system

11 Sealing element

12 Venting system

13 Area of the inside space of the first transmission housing portion

14 Cutout

15 Bore of the sealing element

16 Hollow space of the first transmission housing portion

17, 18 Lines

19 Through-bore of the sealing element

20 Hollow space of the second transmission housing portion

21 Connection line

22 Further hollow space of the second transmission housing portion

23 Bore of the second transmission housing portion

24, 25 Lines

26 Opening area

27 Throttle point

28 Sealing fin

29 Sealing bolt

30 Bore

31 Centering plate

1-9. (canceled)

10. A transmission device (1) having a transmission housing (2) with at least one first transmission housing portion (3) which can be acted upon in an inside space (5) with hydraulic fluid and with a second transmission housing portion (4),
an inside space (6) of the second transmission housing portion (4) being separated from the inside space (5) of the first transmission housing portion (3), and
a sealing system (10) being provided between the two transmission housing portions (3, 4) for sealing the inside space (5) of the first transmission housing portion (3) against escape of oil from the transmission housing (2), and
the inside space (5) of the first transmission housing portion (3) being connected, via a venting system (12), to the inside space (6) of the second transmission housing portion (4),
wherein the connection between the inside space (5) of the first transmission housing portion (3) and the inside space (6) of the second transmission housing portion (4) passes at least once through a sealing element (11) of the sealing system (10).

11. The transmission device according to claim 10, wherein the inside space (5) of the first transmission housing portion (3) is delimited by the second transmission housing portion (4), in an area (13) facing toward the inside space (6) of the second transmission housing portion (4), and the inside space (5) of the first transmission housing portion (3) is connected, via a cutout (14) of the second transmission housing portion (4) and a bore (15) of the sealing element (11), to a hollow space (16) of the venting system (12) delimited by the first transmission housing portion (3) and the sealing element (11).

12. The transmission device according to claim 11, wherein the hollow space (16) of the venting system (12), delimited by the first transmission housing portion (3) and the sealing element (11), is connected via a through-bore (19) of the sealing element (11) to a hollow space (20) of the venting system (12) delimited by the second transmission housing portion (4) and the sealing element (11).

13. The transmission device according to claim 12, wherein the hollow space (20) of the venting system (12), delimited by the second transmission housing portion (4) and the sealing element (11), is connected by a connection line (21) to a further hollow space (22) of the venting system (12) also delimited by the second transmission housing portion (4) and the sealing element (11).

14. The transmission device according to claim 13, wherein the further hollow space (22), delimited by the second transmission housing portion (4) and the sealing element (11), is connected via a bore (23) of the second transmission housing portion (4) to the inside space (6) of the second transmission housing portion (4).

15. The transmission device according to claim 12, wherein the bore (15) and the through-bore (19) of the sealing element (11) are spaced apart from one another at least in a circumferential direction of the transmission housing (2).

16. The transmission device according to claim 14, wherein an opening area (26) of the connection line (21) into the further hollow space (22), delimited by the second transmission housing portion (4) and the sealing element (11), and the bore (23) of the second transmission housing portion (4) that connects the further hollow space (22) to the inside space (6) of the second transmission housing portion (4), are spaced apart from one another at least in a circumferential direction.

17. The transmission device according to claim 12, wherein, the hollow space (16), delimited by the first transmission housing portion (3) and the sealing element (11), has a throttle (27) in the area between the bore (15) and the through-bore (19) of the sealing element (11).

18. The transmission device according to claim 13, wherein the sealing element (11) is formed with a sealing rib (28) that runs in a circumferential direction of the transmission housing (2) which is positioned, when the sealing element (11) is in its fitted position, as a radial extension of the transmission housing (2) between the hollow space (20) delimited by the second transmission housing portion (4) and the sealing element (11), and the further hollow space (22) also delimited by the second transmission housing portion (4) and the sealing element (11).
